(19) United States
(12) Patent Application Publication
(10) Pub. No.: US 2004/0031829 A1
(43) Pub. Date: Feb. 19, 2004

(54) Attachable housing for holding, carrying, and using elongated personal items

(76) Inventors: Christopher Ned Guimond, San Diego, CA (US); Robert Simas JR., Keene, NH (US); Shannon Kwane Stewart, Carmel Valley, CA (US)

Correspondence Address: AARON L. PATTON, 4401 ATLANTIC AVENUE, SUITE 200, LONG BEACH, CA, 90807, US

(21) Appl. No.: 10/638,574

(22) Filed: Aug. 11, 2003

Related U.S. Application Data
(60) Provisional application No. 60/404,370, filed on Aug. 17, 2002.

(51) Int. Cl. B65G 59/00; B65D 83/00; A45F 5/00; A45F 3/00; A45F 3/02; A45C 13/30; A63B 55/00

(52) U.S. Cl. 224/196; 224/604; 224/269

(57) ABSTRACT

An attachable housing for holding, carrying, and using an elongated personal item (such as a dispenser for lip balm, lipstick, or eye shadow, or a small flashlight). The housing comprises a body having an insert opening through it. The body has an inner wall adapted for receiving the personal item. The inner wall has one or more elastic compressible protrusions that grip the personal item when it is inserted into the housing. The personal item is fully useable while in the housing. The housing can be made for use with personal items that have an operating mechanism (such as a wheel) at the bottom; the midsection, or the top; or no operating mechanism. In an embodiment intended for personal items with a bottom-located mechanism, the housing has a base connected to the body bottom by support(s), and the mechanism is accessible through a base opening defined by the base, base support(s), and body bottom, and the base has a pivot acting as a seat for the personal item. The housing can be made without a base opening, as in housings made for personal items that do not have a bottom-located mechanism. A mid-body opening can be provided in housings made for personal items that have a midsection mechanism. The top of the housing can be adapted to enable access to a top-located mechanism. Preferably, the housing is releasably attachable to another item (such as a key ring, key chain, or article of clothing).

### CROSS-REFERENCE TO RELATED APPLICATIONS

This application is derived from U.S. Provisional Application No. 60/404,370, filed Aug. 17, 2002, and claims priority based upon the filing date of said Provisional Application.

### BACKGROUND OF THE INVENTION

The invention relates to devices used for carrying personal items; and more particularly, to housings for carrying personal items that are sold in relatively elongated containers. Examples of such personal items are lip balm, lipstick, and eyeliner dispensers, small flashlights, and the like.

Many people wish to carry one or more personal items for availability and easy use. Unfortunately, most personal items are small and therefore easy to misplace or lose. When carried in a pocket or purse, personal items may be difficult to find or to quickly retrieve. Thus, to make personal items more accessible and usable, it would be desirable to attach them either to some other item (such as a key ring or key chain) that is both commonly-carried and easily located, or to clothing. However, in many cases this cannot be done without some sort of supplemental carrying device. Consequently, there is, and has long been, a need for a carrying device that provides an effective, secure, and reliable means for attachment of a personal item to other items carried by the user or to an article of clothing being worn by the user, while facilitating full use of the personal item without removal from the carrying device. Such a carrying device would be most effective if it could maintain a firm grip on the personal item while the user is engaged in normal activities. Further utility would be realized if the grip were sufficient to hold the personal item in place while it is being used (such as when it is being manipulated for operation or for removal of a cap). The carrying device, however, would have enhanced practicality if the personal item could be easily removed and replaced by the user. Even further utility would be realized if the attachment device could be operated effectively with only one hand. And, a carrying device for personal items is likely to be more desirable if it provides protection to the personal item against impact damage, and is tough, resilient, and resistant to wear and tear, and yet inexpensive to make. Such a carrying device, if it can be produced at a very modest price, would also appear to have enhanced utility as a long-lasting base for advertising, and thereby serve as a useful and attractive promotional item.

There have been some ideas previously disclosed for making devices to carry personal items.

It has been suggested that a pocket made of fabric material with a loop, clip, or ring connected to it can provide a means for carrying and attaching a personal item. (See U.S. Pat. No. 6,360,929 issued to McCarthy; U.S. Pat. No. 6,321,958 issued to Erdmann; and, see products offered for sale by a company named Symbiosis, Inc., through its LEASHABLES division, under the names CHAP-GRIP and LIGHTER GRIP). Fabric devices, however, would appear not to provide the strength of grip on the personal item needed to prevent it from slipping, particularly after extensive use and wear. Any tendency to slip would make it more likely that the personal item might work its way loose from the device. Slipping also would hinder the full and easy operation, particularly by only one hand, of an inserted personal item that requires, for example, the turning of an operating mechanism or the removing of a cap. It is also believed that fabric devices would not provide significant protection to the personal item against impact forces or provide long-lasting durability against wear and tear.

Other previous disclosures relate to devices that do not appear to provide any means for their attachment to another item or to clothing and do not appear intended to facilitate access to any personal-item operating mechanism, nor to be particularly suited for one-hand operation. (See U.S. Pat. No. 2,637,440 issued to Lodewick; U.S. Pat. No. Des. 311,260 issued to Hasert; and, U.S. Pat. No. Des. 377,543 issued to Hanson.) One that does appear to provide a means for operating a personal-item's turning mechanism nevertheless does not appear to provide access to that mechanism while the personal item is inserted. Instead, it appears to require that either the entire carrying device be turned with one hand while the other hand holds the personal item (See U.S. Pat. No. 3,653,776 issued to Gelsel).

One disclosure relates to a device that provides a means for attachment to other items and possibly clothing, but does not appear to allow for full functionality of the personal item while the personal item is inserted into the carrying device nor does the device appear particularly suited for one-hand operation (See U.S. Pat. No. Des. 433,562). And, another disclosure relates to a device that has a means for attachment and appears to allow for full functionality of the personal item while enclosing the device, but also appears to be permanently connected to the personal item, to require rotation of the entire personal item or the carrying device itself to operate the personal item, and to be unsuited to one-hand operation (See U.S. Pat. No. 5,067,836).

Another disclosure relates to a device that provides an attachment means and access to a top-located operating mechanism while enclosing the personal item, and may be suited for one-hand operation, but appears to require the device be in two separable pieces (a shell body and a cap) with the personal item held in place only by flexible flaps around the inside circumference of the top of the cap (U.S. Pat. No. 5,740,905 issued to Kilfoy). This device does not appear to provide access to a bottom-based or mid-level operating mechanism. Also, the means for holding the personal item (set of inwardly bent flaps in the removable cap portion of the device holding only the upper part of the personal item) appears to provide no holding force and no support to the lower portion of the personal item. If the flaps are made to be very flexible, it would appear that the hold on the personal item would be too small to retain the personal item against significant forces due to gravity and movement of the user. If the flaps are made to be quite stiff, for greater holding, their inward orientation would appear to make removal of the personal item difficult, unless the device's cap is first separated from the shell body so the personal item could be pulled in the “inwardly” direction. This device also does not appear intended for use with a personal item having an operating mechanism that rotates in the horizontal plane, causing the personal item to twist when being operated. The device also would appear to require a more complex and expensive manufacturing process than would be needed for a device that can be made as a single piece.

Thus, there appears to be some feature missing from the previously disclosed devices that is desirable for detachably carrying elongated personal items. The present invention addresses the need for a single device that provides those features.

### BRIEF SUMMARY OF THE INVENTION

An object of the present invention is to provide a housing that is suitable for holding and carrying an elongated personal item and that can be attached directly or indirectly (through an intermediary conventional attachment device) to another item (such as a key ring, key chain, or other item commonly carried by the user, or an article of clothing worn by the user) so that the personal item is conveniently available and readily located for use.

A further object of the present invention is for the housing to permit operation of the personal item while it is fully inserted in the housing.

Another object of the present invention is for the housing to permit operation of the fully inserted personal item with only one hand.

A further object of the present invention is for the housing to apply sufficient gripping force to the fully inserted personal item to prevent it from being dislodged from or twisted within the housing under normal usage conditions.

Another object of the invention is for the housing to hold the personal item firmly so it is stabilized when being used.

Another object of the present invention is to provide a housing that can readily be made in different embodiments to suit different usage conditions.

A further object of the present invention is to provide a tough and durable housing that protects the personal item against damage from impact forces under normal use and is sufficiently long-lasting and resistant to wear and tear to be attractive to consumers and as a promotional device bearing advertising.

Another object of the present invention is to provide a housing from which a fully inserted personal item can easily be inserted and removed.

A further object of the present invention is to provide a device that can be made inexpensively.

The present invention is an attachable housing for holding, carrying, and using an elongated personal item. An elongated personal item (referred to in this specification simply as a personal item) is any item with an elongated shape intended for use by an individual person, that is a size and weight the person can easily carry with them in a purse or pocket, including any such item having a mechanism for operating the item (such as for dispensing a substance or for turning the item on or off). Such personal items include but are not limited to dispensers for lip balm, lipstick, or eye shadow, and small flashlights.

The housing comprises a means for firmly holding a personal item of known size, said means being a generally elongated body connected to a base, with an inner wall defining an insert opening that extends through the body. The insert opening is adapted to accommodate insertion of the personal item. The inner wall has at least one elastically compressible protrusion that is adapted to be compressed by and apply a gripping force to the personal item when it is inserted beyond a predetermined distance into the housing. Preferably, the protrusions are flush with the inner wall at the top of the body and gradually increase in depth (of protrusion away from the inner wall) until reaching a transition position slightly beyond the above mentioned predetermined distance. Thus, making insertion of a personal item easier by guiding it toward the point where it is gripped by the protrusions. The compression pressure from each protrusion results in a frictional force on the side of the personal item, resisting its movement. The accumulation of frictional forces from all of the compressed protrusions results in a total gripping force holding the personal item in place against both longitudinal and rotational forces. With a balanced distribution of protrusions around the fully inserted personal item, the personal item also is quite stable. The housing can be made in different embodiments that result from adjustments in such factors as the number, shape, placement (including pattern), compressibility, and friction qualities of the protrusions, in order to adjust the total gripping force for holding the personal item firmly in place under different levels of anticipated user activity. Thus, the housing is able to hold the personal item firmly in place (relative to the housing) while the housing is attached, for example, to another personal item being carried, or to an article of clothing being worn, by the user, and while the user is engaged in normal activities. Likewise, the housing is able to hold the personal item firmly in place while the user uses the personal item, operates the personal item's operating mechanism, if there is one, or removes or replaces the personal item's cap, if there is one.

In embodiments of the housing for use with personal items having an operating mechanism, the personal item has a means for accessing and operating the operating mechanism while the personal item is fully inserted in the housing. Where the operating mechanism is located at or near the bottom of the personal item, the base of the housing comprises a base end and one or more supports, with the supports connected at one end to the base end and at the other end to the body bottom. Each support thereby connects the base end to, and separates it from, the body bottom. The means for accessing and operating the operating mechanism is the arrangement of the base end and supports relative to the body bottom, wherein a base opening is defined which provides sufficient access to the operating mechanism for the user to manipulate the operating mechanism with at least one finger. Preferably, the base opening also provides sufficient access for at least one of the user's fingers to push on the personal item to move it in the outwardly direction when its removal is desired. The operation of the operating mechanism also is made easier, and the chance of interference from contact with the base is reduced, by addition of a pivot on the surface of the base end facing toward the body bottom and centered on the turning axis of the operating mechanism. This pivot, combined with a flexible base, provides another means for assisting in removal of the personal item from the housing. By this means, the user applies finger pressure on the bottom of the base end opposite the pivot, moving the pivot which then pushes on the personal item in an outwardly direction. This enables the user to initiate movement of the personal item so that its upper portion is more exposed and therefore easier for the user to grasp and complete the removal.

In alternative embodiments, such as those for use with personal items that have the operating mechanism located at some place other than near the bottom of the personal item, or that have no operating mechanism at all, the housing can be made with the base replaced by a solid bottom (effectively, a base without supports) connected directly to the body bottom. The solid bottom preferably is flexible and has a pivot connected to its surface facing toward the insert opening, all contributing toward assisting in removal of the personal item from the housing. Although perhaps less effective for providing such assistance, alternative embodiments my have no pivot located on the solid bottom.

In embodiments where the operating mechanism is located in the midsection of the housing body, the housing has at least one mid-body opening defined by a cutout from the midsection wherein the top of the cutout is above, and the bottom of the cutout is below, the location of the operating mechanism of the fully inserted personal item. The mid-body opening is adapted in size and shape to provide a means for the user to access and manipulate the operating mechanism with at least one finger. Preferably, such mid-body opening also provides sufficient access for at least one of the user's fingers to push on the personal item to move it in the outwardly direction when its removal is desired.

The housing's firm hold on the fully inserted personal item makes it possible to fully utilize the personal item using only one hand. In embodiments having an operating mechanism access opening, such as the ones mentioned above with a base opening or a mid-body opening, one-handed operation is further enhanced by the access provided to the operating mechanism. Also, in such embodiments, no protrusion is located in a position that will cause significant interference with the operation of the operating mechanism; preferably, by not being placed where it will make contact with the fully inserted personal item's operating mechanism such as within the base opening or mid-body opening.

Each embodiment of the invention is made so that it can be attached directly or indirectly to, for example, another item (such as a key ring, key chain, or other item carried by the user; or an article of clothing worn by the user) by an attachment means. The attachment means preferably, is the base end having a hole through it. But, the invention also contemplates use of a side piece having a hole through it, a clip connected to the side of the body, or any other conventional means for removably attaching the housing to another item.

The housing is sufficiently simple in form to be made as a single piece in an inexpensive one-piece mold (except for a slideable piece for making embodiments having a hole) and using a plastic injection molding process wherein the housing preferably is made of an inexpensive, light, strong, and high durability plastic material. Of course, other conventional processes and materials can be used to make the housing or any of its parts.

Thus, the present invention provides a housing that makes it possible and convenient for the user to securely carry, easily locate, protect, and fully utilize, a personal item while it is inserted in the housing, and to easily remove and replace the personal item when desired. It also provides a housing that can be made economically, so that it is attractive to consumers and to those who might wish to use the housing as a promotional item for placement of advertising.

Additional objects, features and advantages of the invention will become apparent to the reader upon further review of this specification and the appended drawings.

### BRIEF DESCRIPTION OF INVENTION

The present invention will be more clearly understood by reference to this specification in view of the accompanying drawings, in which:

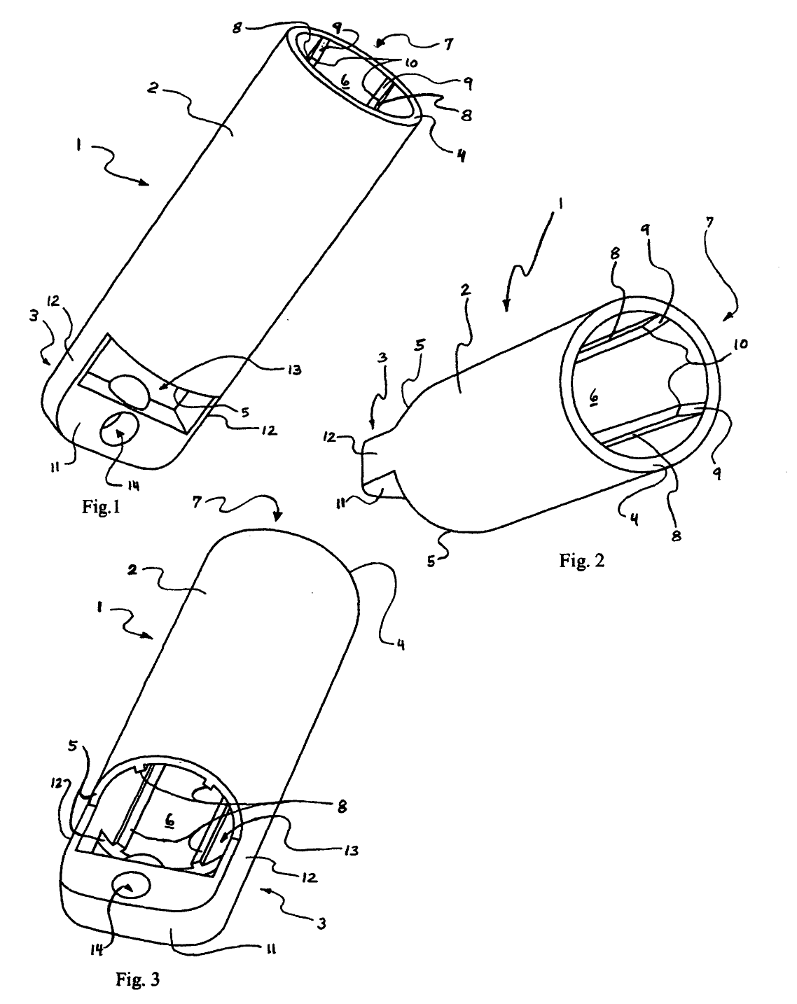

FIG. 1 is a perspective view of a preferred embodiment of the invention.

FIG. 2 is a perspective view of the preferred embodiment shown in FIG. 1, but looking at it from an angle providing better visibility into the top of the insert opening.

FIG. 3 is a perspective view of the preferred embodiment shown in FIG. 1, but looking at it from an angle providing visibility into the bottom of the insert opening.

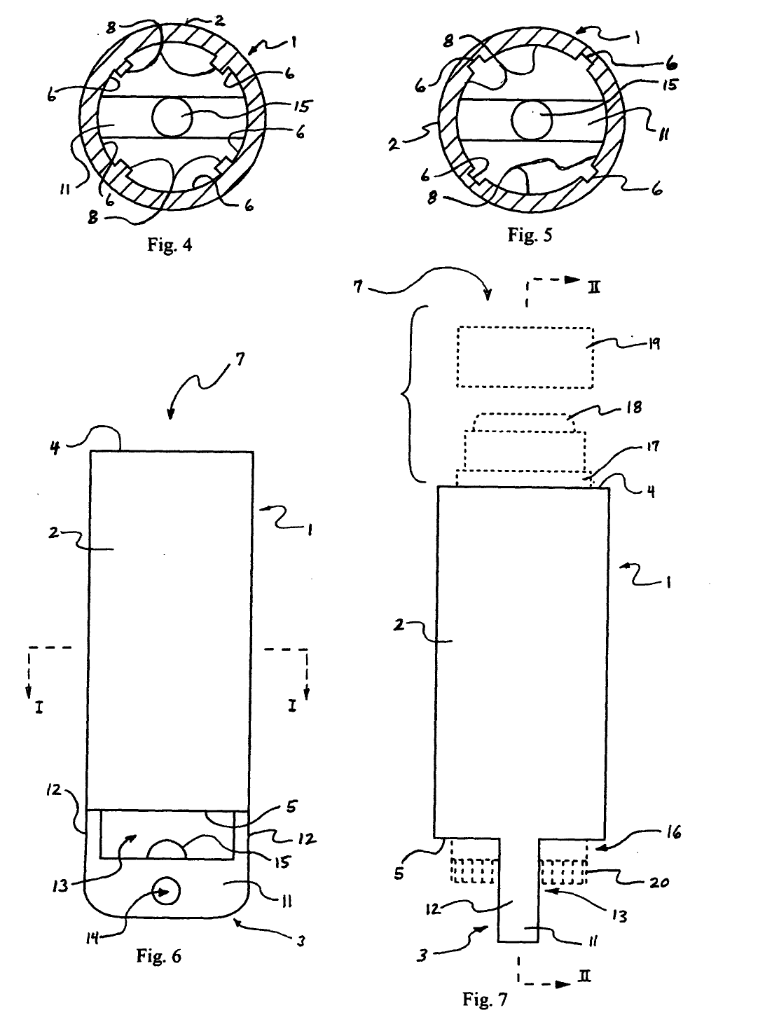

FIG. 4 is a top cross sectional view through I-I of a preferred embodiment similar to that shown in FIG. 1.

FIG. 5 is a top cross sectional view through I-I of a preferred embodiment similar to that shown in FIG. 1, but with an alternative configuration within the insert opening.

FIG. 6 is a front elevation view of a preferred embodiment similar to that shown in FIG. 1, indicating the location of cross sectional cut I-I.

FIG. 7 is a side elevation view of a preferred embodiment similar to that shown in FIG. 1, indicating the location of cross sectional cut II-II and indicating the position of a fully inserted personal item with its cap removed.

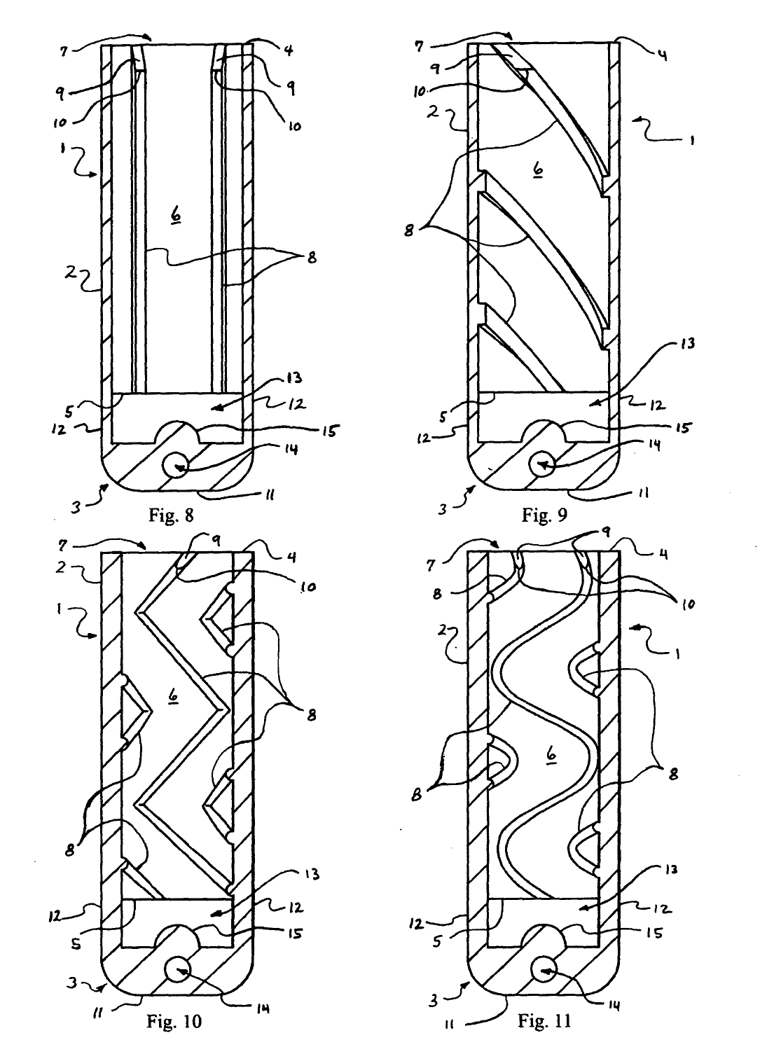

FIG. 8 is a front elevation cross sectional view through II-II of a preferred embodiment similar to that shown in FIG. 1.

FIGS. 9-11 are front elevation cross sectional views through II-II of a preferred embodiment similar to that shown in FIG. 1, but illustrating three alternative configurations for protrusions on the inner wall (with the caveat that the illustrations are not precisely accurate, due to the difficulty of drawing the patterns on the curved surface of the inner wall).

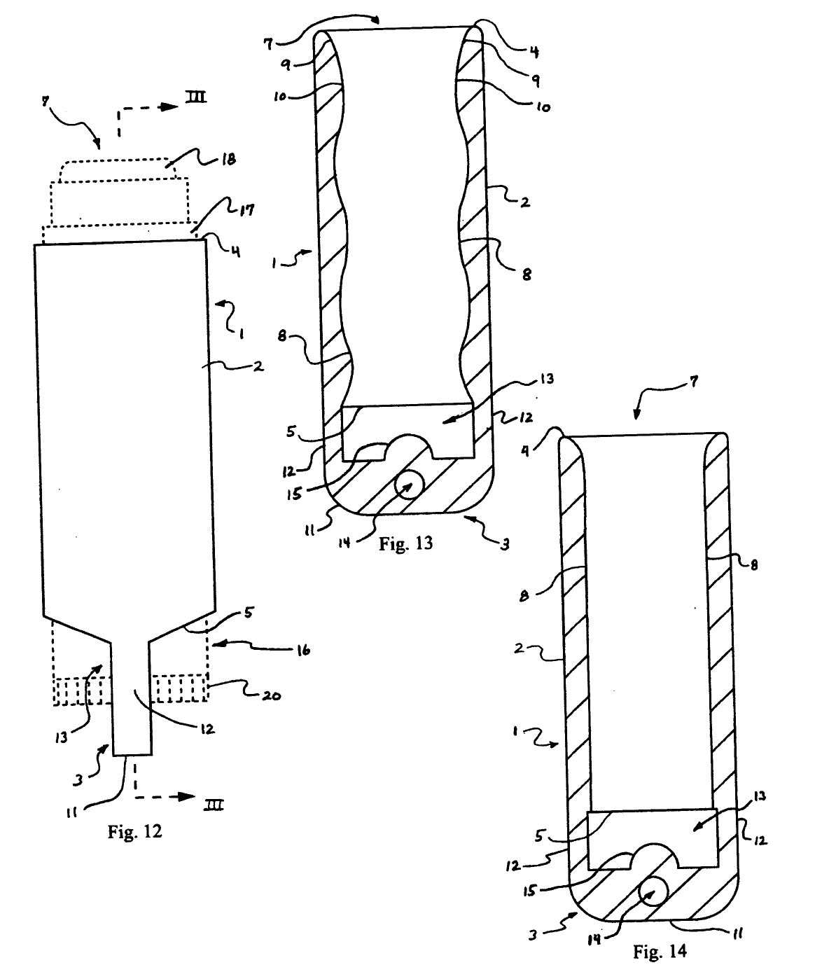

FIG. 12 is a side elevation view of a preferred embodiment similar to that shown in FIG. 1, but with an alternative configuration for the body bottom, indicating the location of cross sectional cut III-III, and indicating the position of a fully inserted personal item without its cap.

FIGS. 13-14 are front elevation cross sectional views through III-III of a preferred embodiment similar to that shown in FIG. 12, but illustrating two alternative configurations for the inner wall protrusion.

FIG. 15 is a front elevation view of a preferred embodiment of the invention with a mid-body opening instead of a base opening and its attachment means on its side, and indicating the position of a fully inserted personal item with its cap removed.

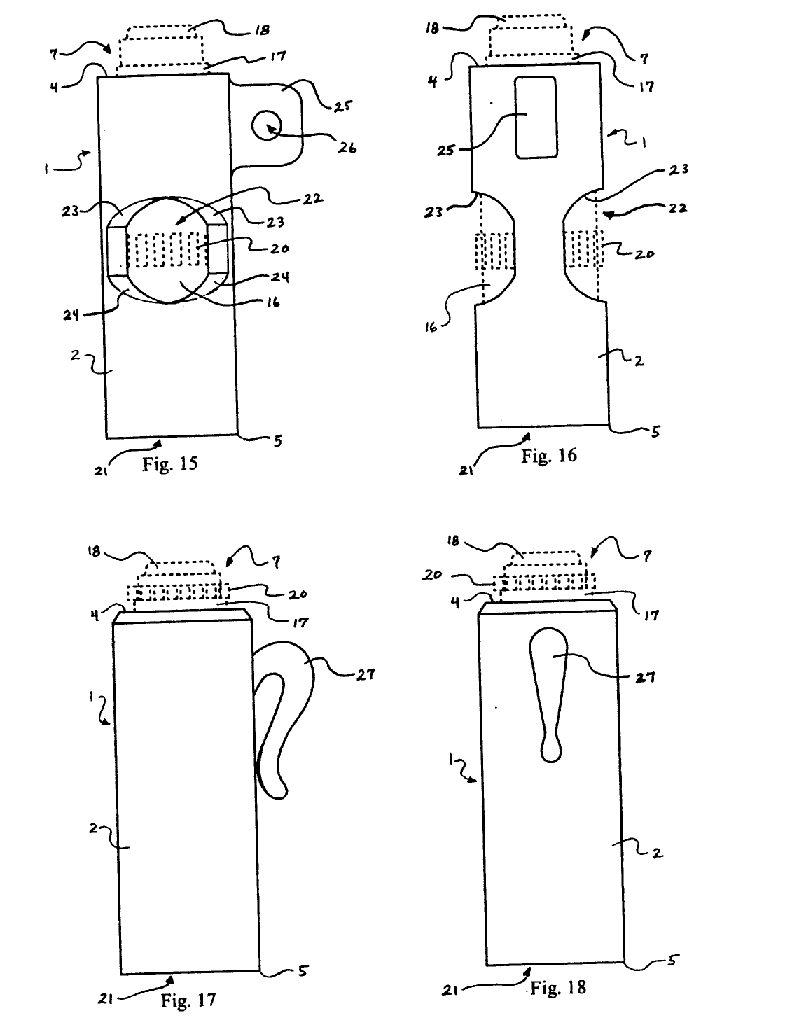

FIG. 16 is a side elevation view of a preferred embodiment similar to that shown in FIG. 15, and indicating the position of a fully inserted personal item with its cap removed.

FIG. 17 is a front elevation view of a preferred embodiment of the invention without a base opening or mid-body opening, with the attachment means located on the side, and indicating the position of a fully inserted personal item with its cap removed.

FIG. 18 is a side elevation view of a preferred embodiment similar to that shown in FIG. 17, and indicating the position of a fully inserted personal item with its cap removed.

### DETAILED DESCRIPTION OF PREFERRED EMBODIMENTS OF THE INVENTION

The present invention is an attachable housing for holding, carrying, and using elongated personal items, and is illustrated in several of its preferred embodiments by the accompanying drawings, designated as FIGS. 1-18.

FIGS. 1-3 show three views of a preferred embodiment. In that embodiment, the housing 1 comprises a body 2 and a base 3. The body 2 is shaped as a circular cylinder with a body top 4, a body bottom 5, and an inner wall 6 that encloses an insert opening 7, the inner wall 6 being shaped as a circular cylinder except for protrusions 8 that are in the form of ribs orientated in the direction of the axis of the insert opening 7. The base 3 has a base end 11 and two base supports 12. The insert opening 7 extends from the body top 4 to the body bottom 5 and is adapted for receiving a personal item 16 (not shown in FIGS. 1-3, but shown in phantom lines in FIG. 7, with its cap 19 shown separated from it, and in FIGS. 12 and 15-18 without its cap) of known dimensions (such as a commercially available product that the housing 1 is intended to be used with). (Each reference in this specification to any shape, size, form, direction, location, position, alignment, distance, or dimension, is not intended to be limited to the exact thing being referred to but is intended to also be a reference to all versions and approximations that are substantially similar to the thing, unless specifically stated otherwise herein.)

FIG. 4 shows a sectional view of the embodiment shown in FIGS. 1-3, looking into the insert opening 7 from the body top 4 toward the base end 11, and FIG. 5 shows a preferred embodiment with an optional configuration of the inner wall 6 and protrusions 8. FIG. 4 shows the inner wall 6 having protrusions 8 in the form of ribs that are narrow relative to the circumference of the insert opening 7, while FIG. 5 shows the inner wall 6 having protrusions 8 in the form of ribs that are much wider than those shown in FIG. 4. In each of these embodiments, the number of protrusions 8 (in the form of ribs) is four and they are equally spaced apart.

The protrusions 8 are elastically compressible. Although preferably the protrusions 8 are in the form of ribs (shown in FIGS. 1-5 and FIGS. 8-11) or bumps (not shown in the drawings), they can, alternatively, be in the form of any other shape, or combination of shapes, protruding from the inner wall 6. However, the type, number, cross-sectional shape, spacing, width and pattern of the protrusions 8, may vary from one embodiment to another. Examples of embodiments wherein the protrusion 8 pattern is other than a straight lines are shown in FIG. 9 (spiraling pattern), FIG. 10 (zigzag pattern), and FIG. 11 (wavy pattern). Also, FIGS. 10 and 11 show the protrusions 8 in those embodiments as having a semicircular cross sectional shape, rather than the essentially rectangular shape shown in FIGS. 1-4 and 8. As seen in FIG. 5, the protrusions 8 can also have an annular cross sectional shape. In other embodiments, the inner wall 6 may have only one protrusion 8, which, in the extreme, may be extensive enough for the single protrusion 8 to cover the entire inner wall 6. Examples of embodiments with the protrusion 8 covering the entire inner wall 6 are shown in FIG. 13 (undulating) and FIG. 14 (straight).

Although, preferably, each protrusion is formed as part of the inner wall (such as by a molding process), the protrusion can, in alternative embodiments, be a separate piece that is connected to the inner wall. (As used in this specification, “connected to” means that the parts being referred to are connected to one another, directly or indirectly, by any conventional means, including, without limitation, by forming them as a single piece in a mold; by applying an adhesive to at least one of them; by heating at least one of them; by placing them under pressure; by riveting them; by stapling them; by welding them; and by curing them.)

Preferably, the inner wall 6 has a protrusion taper section 9 (as shown in FIGS. 1-2 and 8-11) wherein the depth of the protrusion 8 is gradually (though, not necessarily linearly) decreased, beginning at a predetermined transition position 10, and ending at the body top 4. At the body top 4, the protrusion 8 is outside the circumference of the personal item 16 that is to be carried by the housing 1. At the transition position 10, the protrusion 8 is intruding into the circumference of the personal item 16, and will, therefore, be compressed by the personal item 16 when the personal item 16 is installed in the housing 1. FIGS. 13-14, show examples of taper sections 9 wherein the depth of the protrusion 8 within the taper section 9 decreases non-linearly. Although the protrusion 8 surface within the taper section 9, as shown in the FIGS. 13-14 cross-sectional views, is described by a convex curved line, the protrusion 8 surface can be described by any other line capable of guiding the insertion of the personal item 16 toward the transition position 10.

Each compressed protrusion 8 imparts pressure against the surface of the personal item 16, and the cumulative total resulting friction (gripping force) holds the personal item 16 in place. In short, when the personal item 16 is inserted into the housing 1, it is first centered as it passes through the taper section 9 and is then gripped by at least one protrusion 8. The gripping force causes the personal item 16 to resist being dislodged from the housing 1 during normal activity of the user, and to resist shifting or turning within the housing 1 when the operating mechanism 20 of the personal item 16 is manipulated or its cap 19 is removed or replaced. These features of the invention make it useful, not only for carrying and using a personal item 16 under normal circumstances when two hands are available, but also make it useful for facilitating single-handed operation of the personal item 16 while it is in the housing 1.

Housings can be made to apply a greater or lesser total amount of gripping force to a particular personal item of known size, shape, and surface material. This is done, for example, by changing one or more of the following: the number of the protrusions; the placement (including pattern) of the protrusions; the depth of the protrusions (or, put another way, the amount of the encroachment by the protrusions into the path of the personal item); the cross-sectional shape of the protrusions; the total area of contact between the protrusions (and any other parts of the inner wall having contact) and the inserted personal item; the compressibility, friction, or compressibility and friction, qualities of the protrusions (and other parts of the inner wall that have contact with the inserted personal item); and, the flexibility of the body. Thus, a proper configuration is readily determined for achieving the level of gripping force desired. Of course, the level of gripping force desired will vary depending on the intended conditions of use. For example, more gripping force may be desired if the housing is to be attached to the outer garment of a person engaged in athletic activities, and less gripping force may be desired if the housing is to be attached to a key ring or key chain that is carried in a purse or pocket. The strength of the intended user will also affect the level of gripping force desired, since the user must overcome the gripping force when inserting or removing the personal item. So, for example, more gripping force may be desired in housings to be used by healthy adults and less may be desired for housings to be used by young or physically impaired persons.

FIGS. 6-7 show an elevated side view and rear view, respectively, of the preferred embodiment shown in FIGS. 1-3, with FIG. 7 also showing, in phantom lines, a typical personal item 16 fully inserted into the housing 1 (a fully inserted personal item 16). The personal item 16 shown in FIG. 7 has a container 17, contents 18, a cap 19, and an operating mechanism 20 that, in this case, is a wheel for extending and retracting the contents 18. The personal item 16 shown here is a dispenser of lip balm. However, a lip balm dispenser is intended only as an example of, and not as a limitation on, the types of personal items 16 that can be used with the housing 1.

FIGS. 1-14 show preferred embodiments of the housing 1 wherein the base 3 has a base end 11 and two base supports 12, each base support 12 being connected at one end to the base end 11 and at the other end to the body bottom 5. Alternative embodiments (not shown) can have a single base support 12 or, alternatively, more than two base supports 12. An example of an embodiment with more than two base supports 12 would be one with four base supports 12, wherein the base end 11 has a perpendicular side part (not shown) connected to each side of the base end 11, with each of the added (the third and forth) base supports 12 being connected at one end to a different one of the side parts and connected at the other end to the body bottom 5. The base supports 12 hold the base end 11 a predetermined distance from the body bottom 5. The predetermined distance being sufficient to allow the bottom of the fully inserted personal item 16, including any operating mechanism 20 located at or near the bottom of the personal item 16, to be exposed below the body bottom 5. The combination of the body bottom 5, the base supports 12, and the base end 11 define at least one base opening 13 of sufficient size to provide access for an intended user to manipulate the operating mechanism 20 with at least one finger and thereby operate the personal item 16 while it is fully inserted into the housing 1. (As used in this specification, finger includes thumb.) Preferably, the size of the base opening 13 is also sufficient for the user to insert at least one finger under or against the personal item 16 and push it in the axial direction outwardly from its fully inserted position enough to expose the upper portion of the personal item 16 so it can be grasped by the user and removed from the housing 1. The top of the base opening 13, which in FIGS. 1-14 is also the body bottom 5, is shown in FIG. 7 as being at a right angle relative to the base supports 12. However, in alternative embodiments, the top (and bottom if there is one) of the base opening 13 may be any shape that allows sufficient access to the operating mechanism 20 for at least one of the user's fingers to operate it and, preferably, to push it in the axial direction outwardly. Examples of such alternate shapes are the beveled shape shown in FIG. 12 and the concave shape shown in FIG. 16. Another such alternate shape (not shown) would be a convex shape.

None of the embodiments described herein have any protrusion 8 located close enough to the operating mechanism 20 of the fully inserted personal item 16 for the protrusion 8 to interfere with the operation of the operating mechanism 20, although another embodiment of the housing could have one or more protrusions 8 located where they interfere with or temporarily interrupt the operating mechanism 20, as in the case of a protrusion 8 serving as a safety friction lock. Typically, separation between the operating mechanism 20 and all the protrusions 8 is achieved by not having any part of any protrusion 8 within the base opening 13, the mid-body opening 22 (discussed below in connection with FIGS. 15-16), or any other space in which the operating mechanism 20 of the fully inserted personal item 16 is located.

Referring further to the embodiments shown in FIGS. 1-14, the shape of the two base supports 12 and of the base end 11, when viewed from the side (side-view shape) (as shown in FIGS. 6, 8-11, and 13-14) is rectangular except that the base end 11 has curved lower corners; and, the thickness of each base support 12 is the same as the thickness of the base end 11 (as shown in FIGS. 7 and 12). However, in alternative embodiments having at least one base support 12 and a base end 11, each base support 12 and the base end 11 can differ from one another in side-view shape and thickness, and can each have any other side-view shape and any thickness desired, including, for example, a variable thickness forming a cylinder; provided that the base support 12, or base supports 12 if more than one, and the base end 11 are combined and connected substantially as described in this specification.

In the preferred embodiments shown in FIGS. 1-14, the base end 11 has a base pivot 15 centered on the axis of the insert opening 7 and positioned so that the operating mechanism 20 of the personal item 16 rests upon the base pivot 15 when the personal item 16 is fully inserted into the housing 1. The base pivot 15 is sized and shaped to hold the operating mechanism 20 away from the housing 1 surfaces so the operating mechanism 20 can move without being impeded by contact with the housing 1. In the preferred embodiments shown in the drawings, the base pivot 15 is hemispherical in shape. However, showing the base pivot 15 as a hemisphere is not intended to limit or restrict the shapes the base pivot 15 can have in other embodiments. For example, in alternative embodiments, the base pivot 15 can be in the shape of a cylinder or cone, and can be made to have greater or lesser prominence or (in embodiments with no bottom-located operating mechanism) can be eliminated entirely.

Preferably, the base end 11 and base supports 12 are sufficiently flexible for the user to initiate axial movement of the fully inserted personal item 16 outwardly from the housing 1 by pressing a finger against the bottom of the base end 11.

The base end 11 also has a base hole 14 through it. The base hole 14 is adapted for receiving and holding an attaching device such as a ring, loop, clip, or other conventional attachment means that can be used to releasably attach the housing 1 to another item, such as a key ring or key chain (not shown) or to an article of clothing (not shown). Alternative embodiments can have the releasable attaching device screwed into, glued to, or otherwise directly or indirectly connected to the base 3 or the body 2.

FIGS. 15-18 illustrate examples of other embodiments of the invention, wherein the base 3 is replaced by a solid bottom 21 located at the body bottom 5 of the body 2. These embodiments are intended to accommodate personal items 16 that have their operating mechanism 20 located somewhere other than at or near the bottom of the personal item 16. Preferably, the solid bottom 21 is flexible and has a base pivot 15 (not shown in FIGS. 15-18 but shown in FIGS. 1, 34, 8-11, and 13-14) axially located on the inner surface of the solid bottom 21, so that the user can initiate axial movement of the personal item 16 as discussed above with reference to FIGS. 1-14. Alternate embodiments having no base pivot 15, although generally less preferable than those with a base pivot 15, are nevertheless considered to be within the scope of the present invention.

FIGS. 15-16 show an embodiment intended for use with a personal item 16 that has its operating mechanism 20 located approximately at its midsection. This embodiment has a mid-body access opening 22 instead of the base opening 13 referred to above in the discussion of FIGS. 1-14. The mid-body access opening 22 comprises an opening top 23 and an opening bottom 24 that define at least one cut-out section of the body 2, wherein the opening top 23 is above and the opening bottom 24 is below the location of the operating mechanism 20 of the fully inserted personal item 16. The mid-body access opening 22 is similar to the base opening 13 in that it provides access for at least one of the user's fingers to operate the operating mechanism 20 while the personal item 16 is in the housing 1 and to push the personal item 16 outwardly when its removal is desired. The opening top 23 and opening bottom 24 are shown as having a concave shape when viewed from the profile depicted in FIG. 16, but, alternatively, may be any other shape, such as a right-angle, bevel, or convex shape, that provides access to the operating mechanism 20.

FIGS. 17-18 show an embodiment intended for use with a personal item 16 that has its operating mechanism 20 located at or near its top. This embodiment has no access opening but rather is adapted for use with a personal item 16 having its operating mechanism 20 at or near its top so that, when the personal item 16 is fully inserted into the housing 1, the operating mechanism 20 is exposed above the body top 4 and is accessible for operation by at least one of the user's fingers. The outer edge of the body top 4 is shown in FIGS. 17-18 as being beveled, but, alternatively, may be any other shape referred to in the above discussion relating to the opening top 23 and opening bottom 24.

Of course, any embodiment of the housing can be used with a personal item that has no operating mechanism, provided the housing is adapted to receive and grip such personal item substantially as described herein with respect to receiving and gripping a personal item that does have an operating mechanism.

FIGS. 15-18 show two examples of alternative means for attaching the housing 1 to another item or to an article of clothing. FIGS. 15-16 show the attachment means as a side piece 25 connected to the side of the body 2, wherein the side piece 25 has a side-piece hole 26. The side-piece hole 26 is adapted for receiving and holding an attaching device such as a ring, loop, clip, or other conventional attachment means that can be used to releasably attach the housing 1 to another item, such as a key ring or key chain (not shown) or to an article of clothing (not shown). FIGS. 17-18 show the attachment means as an elastic side clip 27, wherein one end of the side clip 27 is connected to the side of the body 2 and the other end of the side clip 27 is elastically pressed against the side of the body 2. The side clip 27 is adapted for releasably attaching the housing 1 to another item, such as a key ring or key chain (not shown) or to an article of clothing (not shown). These examples are not intended to limit the scope of the invention, which may utilize any conventional means for attaching the housing 1 to another item or to an article of clothing.

The preferred method of making the housing is as a single molded piece that is made of an inexpensive, light, strong, and high durability plastic material such as high impact polystyrene or polypropylene, using a plastic injection molding process. The mold can be made simply and inexpensively by limiting it to a single piece with a central core and a surrounding cavity, and having (for configurations wherein the attachment means comprises a hole in any part of the housing) a slidable piece that is inserted into the mold for making the hole and retracted before the housing is extracted from the mold. Mention of this method of making the housing and of making the mold is to illustrate the present invention's suitability for being made by use of simple and inexpensive manufacturing processes and materials, and not to limit the present invention to housings made by use of a specific process, material, or mold that is expressly described herein. For example, the parts and pieces of the housing can be made separately and then connected to one another by any conventional means. The present invention includes housings made, in whole or in part, by any conventional process, such as casting, machining, or etching, and by using any conventional material, including metal, composite, and wood. Where molding is used for making all or any part of the housing, the mold can be made as more than one piece and can have any configuration suited to form the housing or the part or piece being made in it.

A prototype of the housing (similar to the embodiment depicted in FIGS. 1-8, excluding FIG. 5) was made, and found to be effective for testing the prototype with a dispenser of lip balm. The following information relates to that prototype and the dispenser that was used, and is provided here as an additional aid to understanding the present invention. Presentation of this information with regard to the prototype is illustrative only and not intended as a recommendation for its use in the design or manufacture of the housing. The prototype housing was created using stereolithography (a rapid prototyping technique) as a single piece. The material used was a flexible SOMOS 9100 material, and the dimensions of each of the parts were: housing body being a circular cylinder 1.65 inches long (not counting base or supports) and with 0.700 inch outside diameter; cylindrical inner wall with a 0.620 inch diameter, running the full length of housing body; 4 protrusions in the form of straight ribs (of essentially rectangular cross-section, 0.009 inches in depth and 0.020 inches in width) running the full length of the inner wall in the direction of the axis of the housing body, and being equally spaced-apart and non-aligned with the base end; the base end being a rectangular shape with rounded outside lower corners (similar to FIGS. 6 & 7) of 0.200 inch radius, the rectangle being 0.700 inch in length, 0.250 inch in height and 0.200 inch in thickness; the base is supported at each end by a base support that has the same width as the base end and the same thickness as between the body outside diameter and the inner wall diameter, and has a length of 0.250 inches, separating the base end from the body bottom; the pivot is located on the base end facing the housing body and centered on the housing body axis; and, the taper section extends 0.200 inches downward from the body top. The dispenser used for testing this prototype had a bottom-located wheel as its operating mechanism and was a circular cylinder with the following outside dimensions (with the removable cap on): 2.570 inches in height and in 0.610 inches in diameter, and the cap was 0.630 inches in height.

Although particular elements, embodiments and applications of the present invention have been shown and described herein, the invention is not limited thereto, since modifications within the scope of the present invention but not expressly stated herein may be made by those skilled in the art, particularly in view of this specification. The claims, which reflect the scope of what is claimed, are to be read in view of this specification, including definitions set forth therein, and are intended to include all such modifications that come within the spirit and scope of the invention.

What is claimed is:

1. A housing for holding, carrying, and using elongated personal items, comprising—
(a) a body having a body top and a body bottom, and
(b) a means for releasably attaching the housing to another item;
(c) wherein said body comprises,
(i) an inner wall, wherein the inner wall encloses an insert opening that extends through the body from the body top to the body bottom, wherein the insert opening is adapted to accommodate insertion therein of a personal item, said personal item comprising an elongated container of predetermined size and shape;
(ii) at least one elastically compressible protrusion, wherein said protrusion is connected to and protrudes outwardly from the inner wall and into the insert opening,
(A) wherein at least one of the protrusions is adapted to guide the personal item into an intended position within the insert opening when the personal item is inserted into the insert opening through the body top,
(B) wherein at least one of the protrusions is compressed by a fully inserted personal item and thereby applies reactive pressure against the fully inserted personal item such that a gripping force is applied to the personal item;
(C) wherein the gripping forces collectively form a total gripping force that is sufficient to hold the container substantially in place relative to the housing in response to ordinary external forces, wherein said ordinary external forces comprise those forces reasonably expected to act upon the housing, the fully inserted personal item, or both, when a user of the personal item—
(1) engages in normal user activities with the housing connected to the user via the means for releasably attaching the housing to another item,
(2) manipulates the fully inserted personal item as needed to use it, or
(3) both (1) and (2); and,
(D) wherein the total gripping force is not sufficient to prevent the user from manually inserting the personal item into its fully inserted position in the housing and extracting the fully inserted personal item from the housing.

2. The housing of claim 1, wherein the personal item has an operating mechanism, and the housing further comprises a means for providing access to the operating mechanism of the fully inserted personal item by at least one finger (“finger” being inclusive of “thumb”) of the user, whereby the user is able to manipulate the operating mechanism.

3. The housing of claim 2, further comprising a base having a base upper surface and a base lower surface, wherein the base upper surface faces generally toward the insert opening and the base lower surface faces generally away from the insert opening, and wherein the base is connected to the body at or near the body bottom.

4. The housing of claim 3, wherein the base comprises a raised base pivot connected to the base upper surface, wherein the pivot provides a seat for the bottom of the fully inserted personal item.

5. The housing of claim 4, wherein the base is sufficiently elastically flexible for the user to move the pivot toward the body top in response to a force applied by the user's finger to the base lower surface.

6. The housing of claim 5, wherein the means for providing access to the operating mechanism is adapted to enable the user to both hold the housing and manipulate the operating mechanism of the fully inserted personal item using only one hand.

7. The housing of claim 2, wherein the operating mechanism is situated at or near the bottom of the personal item and wherein the base comprises a base end and at least one base support,
(a) wherein the base end has a base upper surface and a base lower surface, wherein the base upper surface faces generally toward the insert opening and the base lower surface faces generally away from the insert opening;
(b) wherein the base support connects the base end to the body at or near the body bottom; and,
(c) wherein the means for providing access to the operating mechanism comprises at least one base access opening defined by the base end, the one or more base supports, and the body bottom.

8. The housing of claim 7, wherein the base end comprises a raised base pivot connected to the base upper surface, wherein the pivot provides a seat for the bottom of the fully inserted personal item.

9. The housing of claim 8, wherein the base is sufficiently elastically flexible for the user to move the pivot toward the body top in response to a force applied by the user's finger to the base lower surface.

10. The housing of claim 9, wherein the means for providing access to the operating mechanism is adapted to enable the user to both hold the housing and manipulate the operating mechanism of the fully inserted personal item using only one hand.

11. The housing of claim 3, wherein the operating mechanism is situated between the bottom of the personal item and the top of the personal item, wherein the means for providing access to the operating mechanism comprises at least one mid-body access opening through the side of the body.

12. The housing of claim 11, wherein the base comprises a raised pivot connected to the base upper surface, wherein the pivot provides a seat for the bottom of the fully inserted personal item.

13. The housing of claim 12, wherein the base is sufficiently elastically flexible for the user to move the pivot toward the body top in response to a force applied by the user's finger to the base lower surface.

14. The housing of claim 13, wherein the means for providing access to the operating mechanism is adapted to enable the user to both hold the housing and manipulate the operating mechanism of the fully inserted personal item using only one hand.

15. The housing of claim 3, wherein the operating mechanism is situated at or near the top of the personal item and the means for providing access to the operating mechanism comprises an access-enabling body top, said access-enabling body top being the body top located and shaped such that at least a portion of the operating mechanism of the fully inserted personal item is exposed.

16. The housing of claim 1, further comprising a base having a base upper surface, a base lower surface, and a flange-shaped portion between the base upper surface and the base lower surface, wherein the base upper surface faces generally toward the insert opening and the base lower surface faces generally away from the insert opening; wherein the base is connected to the body at or near the body bottom; and, wherein the means for releasably attaching the housing to another item comprises a base hole through the flange-shaped portion.

17. The housing of claim 1 wherein the means for releasably attaching the housing to another item comprises a body side part having a hole through it, wherein the body side part is connected to the side of the body.

18. The housing of claim 1, wherein the means for releasably attaching the housing to another item is a clip, wherein the clip is connected to the housing.

19. The housing of claim 1, wherein at least one of the protrusions runs substantially continuously from a point at or near the body top to a point at or near the body bottom along a predetermined path.

20. The housing of claim 1, wherein the housing is made of a single piece of material.

21. The housing of claim 1, wherein the body is adapted to substantially protect the covered portions of the fully inserted personal item against impact damage from said ordinary external forces.
